(19) United States
(12) Patent Application Publication
(10) Pub. No.: US 2015/0364730 A1
(43) Pub. Date: Dec. 17, 2015

(54) BATTERY SHIELD WRAP

(71) Applicant: NITTO DENKO AUTOMOTIVE, INC., Novi, MI (US)

(72) Inventor: Patrick GLASPIE, Waterford, MI (US)

(73) Assignee: NITTO DENKO AUTOMOTIVE, INC., Novi, MI (US)

(21) Appl. No.: 14/710,131

(22) Filed: May 12, 2015

Related U.S. Application Data
(60) Provisional application No. 62/010,560, filed on Jun. 11, 2014.

(51) Int. Cl. H01M 2/02

(52) U.S. Cl. CPC H01M 2/0287; H01M 2/0237; H01M 2/0262; H01M 2/0267; H01M 2/0277; H01M 2220/20

(57) ABSTRACT

A battery shield wrap for wrapping around four sides of a battery, where the wrap is foldable and has four sections such that each of the four sections covers a side of the battery when the wrap is folded. Each of the four sections of the wrap includes a bottom sheet of fabric, a layer of foam, a puncture-resistant substrate and a top sheet of fabric in this order.

### FIELD OF THE INVENTION

The present invention relates generally to a wrap for a battery, such as a battery for use in vehicles, and to a method for manufacturing the wrap. More specifically, the present invention relates to a wrap that protects a battery from damage as a shield and thermally insulates the battery so as to minimize adverse temperature effects of the surrounding environment.

### BACKGROUND OF THE INVENTION

Existing wraps and covers for a battery, such as a battery for use in vehicles, are generally thermal wraps and covers for providing insulation to the battery in order to protect the battery from high temperatures in the summer and low temperatures in the winter. These wraps generally aim to maintain a temperature difference of approximately 15° C. between the temperature of the battery and the temperature of the surrounding environment.

However, in the case of, for example, a battery for use in vehicles, existing wraps and covers do not provide sufficient protection to the battery from damage such as punctures. Accordingly, it is desired to have a battery wrap that simultaneously functions as a shield to protect the battery from external damage and thermally insulates the battery from adverse temperature effects of the surrounding environment.

### SUMMARY OF THE INVENTION

The present invention is a battery shield wrap that simultaneously provides excellent puncture-resistance and thermal insulation to a battery, such as a battery for use in vehicles. For example, a vehicle battery that is wrapped with the battery shield wrap of the present invention is safer for use and decreases the likelihood of battery failure by making the battery puncture-resistant and preventing harmful liquids from leaking from the battery in a vehicle crash. The battery shield wrap also maintains the battery at a cooler temperature when the external temperature is high, such as in the summer time, and at a warmer temperature when the external temperature is low, such as in the wintertime. As a result, the battery shield wrap extends the life of the battery and increases the toughness of the battery.

More specifically, the present invention is a battery shield wrap for wrapping around four sides of a battery, wherein the wrap is foldable and has four sections such that each of the four sections covers a side of the battery when the wrap is folded. Each of the four sections of the wrap comprises a bottom sheet of fabric, a layer of foam, a puncture-resistant substrate and a top sheet of fabric in this order.

In one embodiment of the present invention, in each of the four sections of the wrap, the two sheets of fabric, the layer of foam and the puncture-resistant substrate are hot-melted to each other using a heated forming tool and a press.

In one embodiment, the fabric is preferably a nonwoven fabric. In one embodiment, the puncture-resistant substrate is preferably a metal plate. In one embodiment, the layer of foam is preferably made of urethane.

In another aspect, the present invention provides a method for manufacturing a battery shield wrap for wrapping around four sides of a battery, wherein the wrap is foldable and has four sections such that each of the four sections covers a side of the battery when the wrap is folded. In one embodiment, the method for manufacturing the battery shield wrap comprises the steps of: placing a heated tool to the center of a press and heating the press; placing a bottom sheet of fabric on the heated tool; placing four puncture-resistant substrates on four areas of the bottom sheet of fabric for forming the four sections of the wrap; placing a layer of foam on the bottom sheet of fabric and the puncture-resistant substrates; placing a top sheet of fabric on top of the layer of foam, the puncture-resistant substrates and the bottom sheet of fabric; and hot-melting the top sheet of fabric, the layer of foam, the puncture-resistant substrates and the bottom sheet of fabric to each other by using the press.

Other features, objects, and advantages of the present invention are apparent in the detailed description that follows. It should be understood, however, that the detailed description, while indicating preferred embodiments of the invention, are given by way of illustration only, not limitation. Various changes and modifications within the scope of the invention will become apparent from the detailed description to those skilled in the art.

### BRIEF DESCRIPTION OF THE DRAWINGS

FIG. 1 is a schematic view of a battery shield wrap of the present invention in an unfolded state.

FIG. 2 is a side view of a battery shield wrap of the present invention in a folded state.

FIG. 3 is a top view of a battery shield wrap of the present invention in a folded state.

FIG. 4 is a peel-away view of the layer structure of a battery shield wrap of the present invention.

### DETAILED DESCRIPTION OF THE INVENTION

It is to be understood that the present invention is not limited to the particular embodiments described, as such aspects may vary.

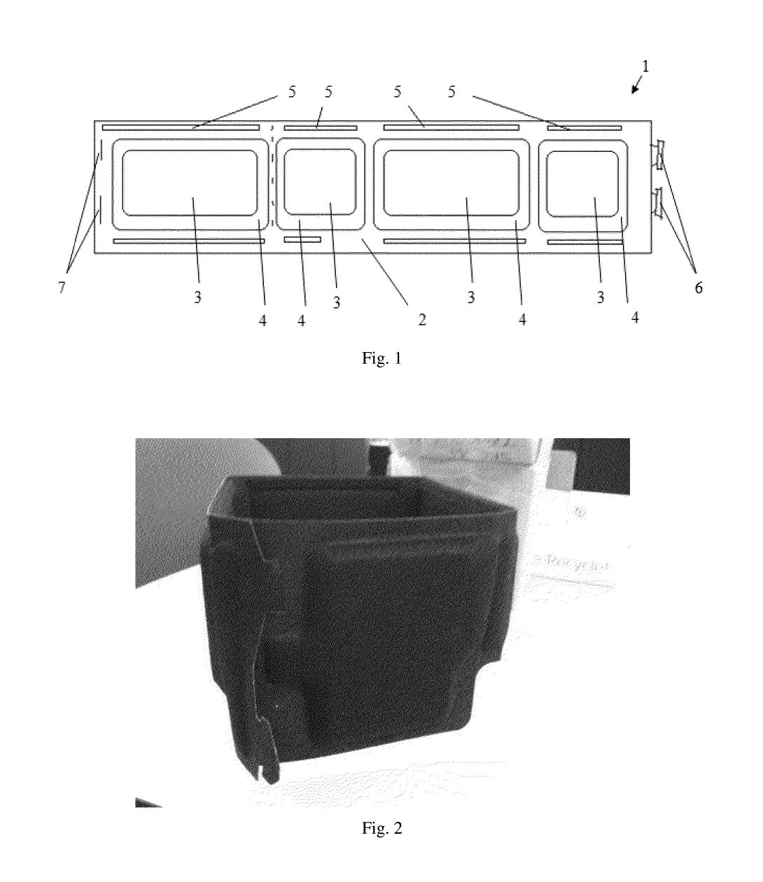

A battery shield wrap of the present invention is for wrapping around four sides of a battery, where the wrap is foldable and has four sections such that each of the four sections covers a side of the battery when the wrap is folded. FIG. 1 illustrates a battery shield wrap 1 of the present invention in an unfolded state. Each of the four sections of the wrap 1 comprises a bottom sheet of fabric 2, a layer of foam 4, a puncture-resistant substrate 3 and a top sheet of fabric in this order. The physical dimensions of the bottom sheet of fabric 2, the layer of foam 4, the puncture-resistant substrate 3 and the top sheet of fabric are not particularly limited, and can be cut out, shaped and folded into different sizes, forms and shapes.

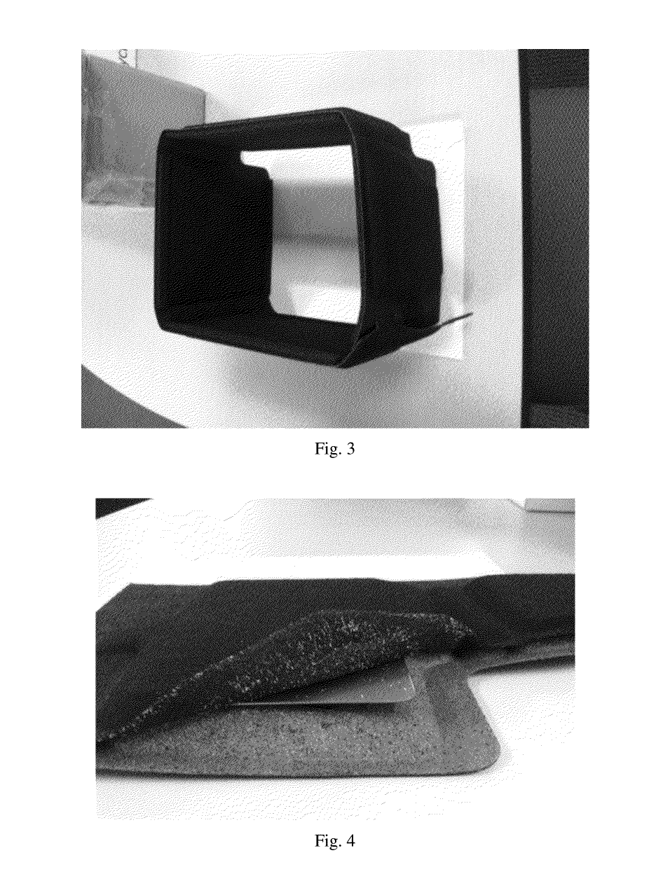

In each of the four sections of the wrap 1, the bottom sheet of fabric 2, the layer of foam 4, the puncture-resistant substrate 3 and the top sheet of fabric are preferably hot-melted to each other using a heated forming tool and a press. In one embodiment of the present invention, an end of the wrap has locking tabs 6 and an opposite end of the wrap has slots 7 such that the wrap can be folded and wrapped around a battery with the tabs 6 locked into the slots 7. FIG. 2 and FIG. 3 illustrate a battery shield wrap of the present invention in a folded state from the side view and the top view, respectively. FIG. 4 illustrates a peel-away view of the layer structure of a battery shield wrap of the present invention.

The bottom sheet of fabric and the top sheet of fabric are each made of either a nonwoven fabric or a woven fabric, and are each preferably made of a nonwoven fabric. The nonwoven fabric can be formed by, for example, mechanical bonding. For example, a nonwoven fabric formed from a polyester fiber can be used. The nonwoven fabric can be treated, such as with an oil/water repellant, flame retardant, or adhesive coating. An example of a commercially available non-woven fabric that can be used is Zetafelt G 9/4201/100 K81 by Tenowo, Inc. The thickness of each sheet of fabric is preferably from about 0.03 mm to about 1 mm, and more preferably about 0.03 mm.

The layer of foam is preferably made of a polymer foam, and more preferably a polyurethane foam. For example, a commercially available flexible polyurethane foam that can be used is Cresthane® by Crest Foam Industries. The thickness of the layer of foam is preferably from about 10 mm to about 25 mm, and more preferably about 15 mm.

The puncture-resistant substrate can be a metal plate, a nylon substrate or a carbon fiber substrate, and is preferably a metal plate. The metal of the metal plate can be steel or aluminum. The metal of the metal plate is preferably steel and, more preferably, cold-rolled steel. The puncture-resistant substrate may be subject to a surface treatment using a suitable surface treatment agent, such as a rust resistant agent. For example, a metal plate may be E-coated for rust resistance. The puncture-resistant substrate preferably has rounded corner edges to prevent the corners of the puncture-resistant substrate from puncturing the wrap. The puncture-resistant substrate is preferably about 8 mm to about 10 mm smaller in both length and width than the layer of foam in order to allow the fabric to flow to the sealed edges. The thickness of the puncture-resistant substrate is preferably from about 0.8 mm to about 2 mm, and more preferably about 0.8 mm.

In addition, an adhesive is optionally used on the surface of the puncture-resistant substrate that faces the layer of foam to prevent the puncture-resistant substrate from shaking and rattling in the wrap. The adhesive is not limited, but can be, for example, an acrylic adhesive. In addition, an adhesive tape, such as No. 512 Adhesive Tape by Nitto Denko Corporation, No. 501L Adhesive Tape by Nitto Denko Corporation and EW-514 Adhesive Tape by Nitto Denko Corporation, can be used for the adhesive on the surface of the puncture-resistant substrate facing the layer of foam.

Further, as illustrated in FIG. 1, foam strips 5 are optionally placed on the sheet of fabric near the edges of the fabric in order to maintain a distance between the fabric and the battery and to keep the fabric in place. The foam strips are preferably made of ethylene-propylene terpolymer (EPT) or polyurethane, and are more preferably made of EPT, where the EPT can be closed cell EPT or semi-closed cell EPT.

In another aspect, the present invention provides a method for manufacturing a battery shield wrap for wrapping around four sides of a battery, where the wrap is foldable and has four sections such that each of the four sections covers a side of the battery when the wrap is folded. A heated tool and press are preferably used for assembling the sheets of fabric, the puncture-resistant substrate and the layer of foam together to form a battery shield wrap.

In one embodiment, the method for manufacturing the battery shield wrap comprises the steps of: placing a heated tool to the center of a press and heating the press; placing a bottom sheet of fabric on the heated tool; placing four puncture-resistant substrates on four areas of the bottom sheet of fabric for forming the four sections of the wrap; placing a layer of foam on the bottom sheet of fabric and the puncture-resistant substrates; placing a top sheet of fabric on top of the layer of foam, the puncture-resistant substrates and the bottom sheet of fabric; and hot-melting the top sheet of fabric, the layer of foam, the puncture-resistant substrates and the bottom sheet of fabric to each other by using the press.

The press is preferably heated to a temperature of 175 to 185° C. When placing the sheets of fabric, the excess fabric may lay over the ends of the tool. The puncture-resistant substrates are pre-cut before placement on the bottom sheet of fabric in order to fit the cavities of the tool. In addition, when placing the puncture-resistant substrates on the bottom sheet of the fabric, the puncture-resistant substrates are preferably placed on the fabric in areas where the cavities of the tooling are located. Furthermore, a locating tool such as a laser projection locating tool may be used to precisely locate where each puncture-resistant substrate should be disposed in each of the cavities of the tooling. After the hot-melting step, the resulting product can be sent to a trimming station where excess fabric can be trimmed away and the foam strips can be installed on the fabric. In another embodiment, the heating step in the beginning of the method can be performed at the same time as the trimming process, and the foam strips can be subsequently installed on the fabric after the hot-melting step.

The battery shield wrap of the present invention simultaneously provides excellent puncture-resistance and thermal insulation to a battery, such as a battery for use in vehicles. As a result, the battery shield wrap extends the life of the battery and increases the toughness of the battery. The design and use of the battery shield wrap of the present invention can be manipulated and manufactured for use in all OEM vehicles, including electric vehicles. For example, a vehicle battery that is wrapped with the battery shield wrap of the present invention is safer for use and decreases the likelihood of battery failure by making the battery puncture-resistant and preventing harmful liquids from leaking from the battery in a vehicle crash. The battery shield wrap maintains the battery at a cooler temperature when the external temperature is high, such as in the summer time, and at a warmer temperature when the external temperature is low, such as in the wintertime.

### EXAMPLE 1

A heated tool is positioned to the center of a press, and the press is heated to a temperature of 180° C. A bottom sheet of nonwoven fabric (Zetafelt G 9/4201/100 K81 by Tenowo, Inc.; having a width of 430 mm, a length of 510 mm and a thickness of 0.03 mm) is placed on the heated tool, and four cold-rolled steel plates (each plate having a width and length of 83 mm×185 mm, 117 mm×117 mm, 70 mm×185 mm, and 80 mm×117 mm, respectively, and each plate having a thickness of 0.8 mm) are placed on four areas of the bottom sheet of fabric in areas where the cavities of the tooling are located for forming the four sections of the wrap. Layers of flexible polyurethane foam (Cresthane® by Crest Foam Industries; each having a thickness of 15 mm) are placed on the steel plates.

Subsequently, a top sheet of nonwoven fabric made of the same material as the bottom sheet of nonwoven fabric is placed on top of the layer of foam, the steel plates and the bottom sheet of nonwoven fabric; and the top sheet of nonwoven fabric, the layer of polyurethane foam, the steel plates and the bottom sheet of nonwoven fabric are hot-melted to each other by using the press. After the hot-melting step, excess fabric is trimmed away from the resulting product, and the foam strips can be installed on the nonwoven fabric to form a battery shield wrap.

The puncture-resistance of the battery shield wrap may be tested by using, for example, a multi-axial impact test. In a multi-axial impact test, the battery shield wrap of the present invention is capable of withstanding an impact having a velocity of, for example, up to or greater than 30 miles per hour.

The foregoing description of the present invention provides illustration and description, but is not intended to be exhaustive or to limit the invention to the precise one disclosed. Modifications and variations are possible in light of the above teachings or may be acquired from practice of the invention. Thus, it is noted that the scope of the invention is defined by the claims and their equivalents.

What is claimed is:

1. A battery shield wrap, comprising four sections, wherein each of the four sections is foldable, and wherein each of the four sections of the wrap comprises a bottom sheet of fabric, a layer of foam, a puncture-resistant substrate and a top sheet of fabric.

2. The battery shield wrap according to claim 1, wherein the fabric is a nonwoven fabric.

3. The battery shield wrap according to claim 1, wherein the foam is a polymer foam.

4. The battery shield wrap accord to claim 1, wherein the puncture-resistant substrate is metal plate, a nylon substrate, or a carbon fiber.

5. The battery shield wrap according to claim 2, wherein the nonwoven fabric if formed from polyester fiber.

6. The battery shield wrap according to claim 3, wherein the polymer foam is a polyurethane foam.

7. The battery shield wrap accord to claim 4, wherein the puncture-resistant substrate is a metal plate.

8. The battery shield wrap accord to claim 7, wherein the metal plate is steel or aluminum.
